(19) United States
(12) Patent Application Publication
(10) Pub. No.: US 2012/0298387 A1
(43) Pub. Date: Nov. 29, 2012

(54) COUPLING HOOK FOR A LOWER LINK OF AN AGRICULTURAL TRACTOR

(76) Inventor: Hans Sauermann, Ernsgaden (DE)

(21) Appl. No.: 13/304,559

(22) Filed: Nov. 25, 2011

(30) Foreign Application Priority Data
Dec. 2, 2010 (DE) 20 2010 016 051.0

(51) Int. Cl. A01B 59/042; A01B 59/043

(52) U.S. Cl. 172/272

(57) ABSTRACT

A coupling hook forms the end piece of a lower link of an agricultural tractor. The coupling hook has a hook body with a receptacle for a coupling body. The hook body has a receiving chamber in which a safety catch is held. The safety catch can be adjusted between a blocking position engaging over the coupling body and a pulled-back release position. By pressing the coupling body into the receptacle of the hook body, the safety catch can be transferred into an activation position from which it is automatically transferred into the blocking position. In order to increase the operational safety of the coupling hook, the safety catch is operatively connected to at least one cam of an adjustable blocking lever. The cam retains the safety catch in the blocking position, preventing a force originating from the coupling body from being able to adjust the safety catch.

### FIELD OF THE INVENTION

The invention relates to a coupling hook for a lower link of an agricultural tractor.

### DESCRIPTION OF THE PRIOR ART

DE 24 56 971 B1 discloses a coupling hook of the type in question. This coupling hook has a hook body and a receiving chamber in which a safety catch is held. Said safety catch is held such that it can be adjusted between a blocking position engaging over a spherical coupling body and a releasing position pulled back into the receiving chamber. For this purpose, a locking lever which forms a toggle lever with the safety catch is provided in the receiving chamber. Said toggle lever is designed here in such a manner that, as the coupling body presses into the receptacle of the coupling hook, the safety catch is transferred into the locking position thereof. Automatic hitching of the coupling body is therefore ensured. This coupling hook has been tried and tested many times in practice and forms the starting point of the present invention.

It has turned out in practice that the coupling hook which is described at the beginning and is of the type in question does not have sufficient operational reliability. Time and again, an implement hitched correctly, for example a plough, becomes lost during travel over rough ground. Although these events are happily rare, they result in considerable damage to the hitched implement. Not least, this lack of reliability of the coupling system also constitutes a considerable risk of accident. It should be taken into consideration here that agricultural tractors are also used in public traffic. If an agricultural tractor loses its mounted implement in public traffic, this constitutes an extreme risk to the following traffic and may even result in fatalities.

### BRIEF SUMMARY OF THE INVENTION

The invention is based on the object of providing a coupling hook of the type mentioned at the beginning, which is distinguished by increased operational reliability without abandoning the automatic hitching function.

This object is achieved by the following features.

A coupling hook preferably forms the free end of a lower link of an agricultural tractor. Said coupling hook has a hook body in which at least one receptacle for a coupling body is provided. Said coupling body is preferably of partially spherical design and is part of a mounted implement which is to be connected to the agricultural tractor. In this case, said mounted implement is connected to the agricultural tractor preferably via a three-point suspension means consisting of two lower links and an upper link. The hook body also has a receiving chamber in which at least one safety catch is held. The accommodating of the safety catch in a receiving chamber has the advantage that the entire mechanism for blocking and releasing the coupling body is accommodated in a space-saving manner. In addition, said mechanism is thereby reliably protected from the ingress of dirt. The safety catch here can be adjusted between a locking blocking position engaging over the coupling body and a release position in which it is pulled back into the receiving chamber to an extent such that the coupling body can be removed from the receptacle. The safety catch therefore provides the required security which holds the coupling body in the receptacle in the hook body. In order to permit automatic hitching, the coupling body, as it penetrates the receptacle in the hook body, can adjust the safety catch into an activation position such that the safety catch is subsequently automatically transferred into the blocking position. In practice, this is achieved in an extremely simple manner by the safety catch still slightly engaging over the coupling body in the release position, wherein said safety catch is pressed resiliently against the coupling body. The coupling body can then press the safety catch further back such that retention of the safety catch is released in the release position and the safety catch is subsequently transferred by spring force into the blocking position thereof.

However, the safety catch therefore has freedom of movement in the direction of the release position. In particular, when the agricultural tractor is traveling over rough ground, the coupling body may execute rotational movements about the transverse axis thereof. Said rotational movements may result in transmissions of torque to the safety catch such that the latter is inadvertently transferred into the release position. In order to solve this problem, provision is made for the safety catch to withstand a force on the safety catch originating from the coupled coupling body. The safety catch is accordingly locked in the blocking position thereof. However, this measure by itself would have the consequence that the desired automatic hitching operation would no longer be possible. If it is attempted to press the coupling body past the safety catch into the receptacle, the safety catch, which is in the blocking position, would block the path of the coupling body. In order to maintain the desired automatic hitching option, the safety catch, despite the retention thereof in the blocking position, has to be able to be transferred into the release position. These contradictory requirements are brought into harmony by a differentiated retention of the safety catch. In this case, provision is made for the safety catch to be able to be transferred into the release position by a force directed towards the receptacle in the hook body. This results in the coupling body, which is located outside the receptacle, being able to press the safety catch into the release position whereas said coupling body, in the coupled position thereof in the receptacle, cannot transmit any movement whatsoever to the safety catch. In order to realize this differentiated retention of the safety catch, the safety catch interacts with at least one cam of the at least one adjustable blocking lever. The freedom of movement of the safety catch can therefore be set in a differentiated manner by the position of the blocking lever and therefore of the cam. In order, in addition, to permit a desired decoupling of the coupling body from the receptacle, the safety catch may also be transferred into the release position by adjustment of the blocking lever. Apart from springs for generating a prestress, only two moveable parts and a fixed hook housing are required in order to obtain all of the abovementioned functions. The result is therefore a simple and consequently cost-effective and reliable mechanism.

In order to obtain the desired differentiated blocking action of the safety catch, it is advantageous, if the safety catch can be adjusted to a limited extent in the direction of the receptacle. In this case, provision is made for the safety catch, in a hitching position adjusted with respect to the receptacle, to be pressable into the release position. By contrast, in a non-adjusted retaining position, the safety catch is retained in the blocking position. It is thereby possible very simply to differentiate between a force directed towards the receptacle of the hook body and a corresponding counterforce. During the hitching operation, the coupling body presses the safety catch slightly in the direction of the receptacle and thereby transfers the safety catch into the hitching position. If, by contrast, the coupling body is located in the receptacle, adjustment of the safety catch into the hitching position is not possible at all, since the coupling body presses the safety catch counter to the receptacle. This provides the desired differentiation in the freedom of movement of the safety catch without in any way impairing the security of the coupling.

In order to obtain simple automatic hitchability, it is favourable, if the safety catch is resiliently prestressed in the direction of the blocking position. In addition, in order to increase the security of the coupling, it is expedient if the blocking lever is resiliently prestressed in the direction of the blocking position, in which the safety catch is retained.

In order to realise a simple construction of the coupling hook, it is favourable, if the safety catch has at least one slotted guide or guide surface on which the cam of the blocking lever acts. With a slotted guide or guide surface, the desired function of the safety catch and blocking lever can be coordinated to a very fine degree, and therefore the entire mechanism can be realized very compactly.

In order for the safety catch to be sufficiently retained in the blocking and release positions thereof, it is advantageous, if the slotted guide or guide surface has at least one latching recess. The cam of the blocking lever engages in said latching recess.

The latching recess for the blocking position of the safety catch is shaped, in such a manner that the cam can emerge from the latching recess by adjustment of the safety catch in the direction of the receptacle. It is therefore ensured that the safety catch can be freely pivoted when adjusted in the direction of the receptacle whereas said safety catch is otherwise retained in the blocking position thereof.

In order to be able to carry out the decoupling operation also in a remote-controlled manner from the seat of the agricultural tractor, it is advantageous, if the blocking lever is acted upon by at least one lifting cylinder, Bowden cable or cable. With said Bowden cable or cable, the safety catch can then be transferred in a remote-controlled manner into the release position thereof. This is possible in a simple manner in particular because, for the transfer into the release position, the free end of the blocking lever can execute a horizontal movement directed towards the agricultural tractor. The cable or the Bowden cable can also be deflected via one or more deflecting means, in particular rollers. The lifting cylinder may be actuated hydraulically, pneumatically or electrically and also permits remote operation of the final coupling.

In order to prevent any transmission of torques from the coupling body to the safety catch, it is alternatively or additionally possible, for the safety catch to be provided with at least one roller detecting the coupling body. Upon rotation of the coupling body, the roller is rotated about its axis, and therefore the entire safety catch remains in its position. This also prevents an undesirable transfer of the safety catch into the release position. The effect achieved by a combination with the above-described cam control according to Claim 1 is that forces are kept away from the blocking mechanism of the safety catch, and therefore the coupling hook operates very reliably.

It is favourable if the at least one roller is in engagement with the coupling body only after a pivoting movement of the safety catch upwards. This protects the mounting of the roller, and therefore the latter is stressed only if it is actually also required in order to prevent transmission of torques from the coupling body to the safety catch.

Finally, it is advantageous, if the safety catch is monitored by at least one sensor. Said sensor is preferably connected to a signal transmitter in the agricultural tractor, which signal transmitter outputs a warning signal if the coupling hook is not correctly locked. The warning signal can be output optically and/or acoustically by the signal transmitter being designed as a control light and/or loudspeaker. This prevents the agricultural tractor being moved when the coupling hook is inadequately locked.

Further advantages and features of the present invention are presented in the following detailed description with reference to the accompanying figure which contains an exemplary embodiment of the present invention. It should be understood, however, that the drawing serves merely for the purpose of illustrating the invention and does not restrict the scope of protection of the invention.

### BRIEF DESCRIPTION OF THE SEVERAL VIEWS OF DRAWINGS

In the drawing:

FIG. 1 shows a sectional illustration through a first embodiment of a coupling hook in the blocking position,

FIG. 2 shows the coupling hook according to FIG. 1 in the release position,

FIG. 3 shows the coupling hook according to FIG. 1 in the activation position,

FIG. 4 shows the coupling hook according to FIG. 1 in the closure position,

FIG. 5 shows a sectional illustration through a second embodiment of a coupling hook in the blocking position,

FIG. 6 shows the coupling hook according to FIG. 5 in the release position,

FIG. 7 shows the coupling hook according to FIG. 5 in the activation position, and

FIG. 8 shows the coupling hook according to FIG. 5 in the closure position.

### DETAILED DESCRIPTION OF THE INVENTION

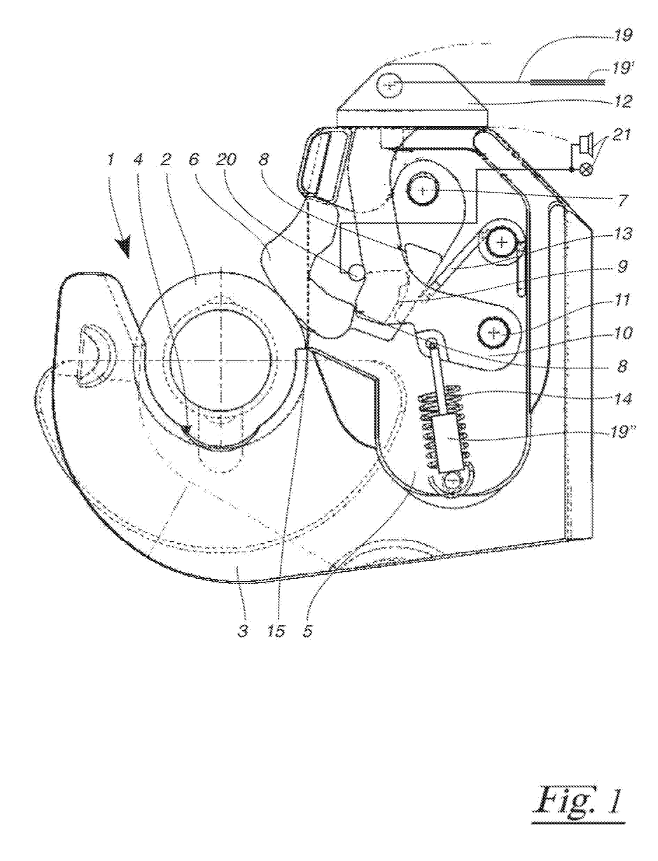

FIG. 1 shows a sectional illustration of a coupling hook for a lower link of an agricultural tractor, with a coupling body 2 inserted. The coupling body 2 is of essentially partially spherical design. It is the coupling member of a mounted implement, for example a plough, to be connected to the agricultural tractor. The coupling hook 1 has a hook body 3 with a receptacle 4, in which the coupling body 2 is accommodated.

In addition, the coupling hook 1 has a receiving chamber 5, in which a safety catch 6 is held. The safety catch 6 is mounted pivotably about an axis 7 and can be displaced slightly in the vertical direction relative to the axis 7. In this case, the safety catch engages over the coupling body 2 in the blocking position illustrated in FIG. 1, and therefore said coupling body cannot inadvertently leave the receptacle 4 of the coupling hook 1.

The safety catch 6 has guide surfaces 8 which interact with a cam 9 of a blocking lever 10. The blocking lever 10 is mounted pivotably about a further axis 11 and is accessible from the outside by means of a handle 12. In addition, it is conceivable to keep a cable or a Bowden cable in the upper end region of the blocking lever 10 in order also to be able to pivot the blocking lever 10 in a remote-controlled manner.

The safety catch 6 is operatively connected to a torsion spring 13 which presses the safety catch 6 into the blocking position illustrated. The blocking lever 10 is loaded by a tension spring 14 which likewise prestresses said blocking lever into the blocking position illustrated.

In the blocking position illustrated, the cam 9 presses against the guide surface 8, and therefore the safety catch 6 is retained in the blocking position thereof. If the coupling body 2 executes rotational movements, it is not possible for any torques whatsoever to be transmitted to the safety catch 6 in order to pivot the latter out of the blocking position thereof. It is therefore no longer possible for the coupling body 2 to unintentionally leave the receptacle 4 of the coupling hook 1.

In addition, a rotatable roller 15 which is operatively connected to the coupling body 2 is supported on the safety catch 6. This additionally increases the security, since torques which originate from the coupling body 2 lead to a rotational movement of the roller 15 and, consequently, cannot adjust the safety catch 6. Torques of this type are therefore not introduced into the pivot mounting of the safety catch 6. If the free rotatability of the roller 15 should be impaired, for example by the accumulation of dirt, possible torques which act on the safety catch 6 are supported by the cam 9.

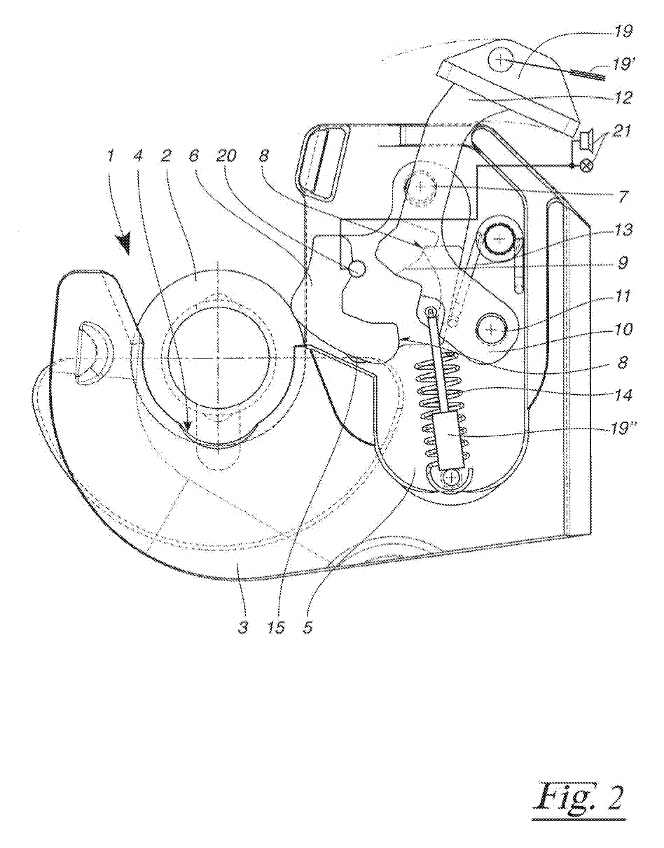

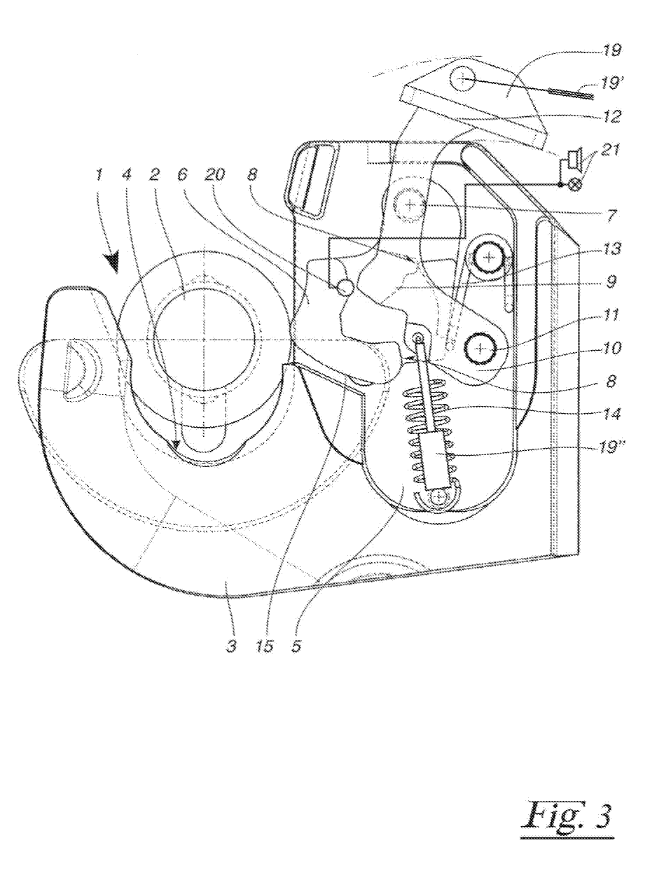

In the blocking position illustrated, a region of the coupling hook 1 below the handle 12 is formed with a conspicuous colour, for example a signaling colour, such as red. This coloured point of the coupling hook 1 is therefore concealed in the blocking position illustrated. If, by contrast, the handle 12 is not in the blocking position thereof but rather in a different position, which is illustrated in FIGS. 2 and 3, said region indicated in colour can be seen and warns the user that the coupling hook 1 is not correctly locked. This increases the security of the coupling hook 1.

As an alternative or in addition, the coupling hook 1 has a sensor 20 which detects the position of the handle 12. In the blocking position illustrated in FIG. 1, the sensor 20 delivers an inactive signal, and therefore an acoustic or optical signal transmitter connected to said sensor is inactive. If, by contrast, the position of the handle 12 differs from the position illustrated, the acoustic and/or optical signal transmitter 21 becomes active.

A cable 19 or Bowden cable 19′ can act on the blocking lever 10 in order to permit a remotely actuated movement of the blocking lever 10. In this case, the cable 19 or the Bowden cable 19′ is preferably guided into the vicinity of the driver's seat of the agricultural tractor. As an alternative, the blocking lever 10 may also be actuated by a lifting cylinder 19″. Said lifting cylinder 19″ may be designed as a hydraulic, pneumatic or electric lifting cylinder 19″. Remote actuation of the handle 12 is thereby also possible.

FIG. 2 shows the coupling hook according to FIG. 1 in the release position. In this case, the blocking lever 10 is pivoted in the clockwise direction such that the cam 9 is disengaged from the guide surface 8. During the pivoting of the blocking lever 10, the safety catch 6 is pivoted by interaction of the cam 9 with the guide surface 8, and therefore the blocking lever 10 is largely pulled back into the receiving chamber 5. However, the safety catch 6 nevertheless engages slightly over the coupling body 2, which is of significance for the further function of the coupling hook 1. The safety catch 6 and the blocking lever 10 are retained in said release position in such a manner that, although the safety catch 6 can be freely pivoted into the receiving chamber 5, the blocking lever 10 remains in the release position illustrated.

FIG. 3 shows the coupling hook according to FIG. 1 in the activation position thereof. This is achieved by the coupling body 2 being pressed from above towards the receptacle 4. In the process, the safety catch 6 is adjusted downwards and at the same time pivots into the receiving chamber 5. Owing to the safety catch 6 engaging over the receptacle 4, this is possible not only in the blocking position but also in the release position of the safety catch 6. By this means, the retaining of the blocking lever 10 is released since the cam 9 is disengaged from the guide surface 8. The blocking lever 10 can therefore be freely pivoted and is pivoted in the direction of the blocking position thereof on account of the spring 14.

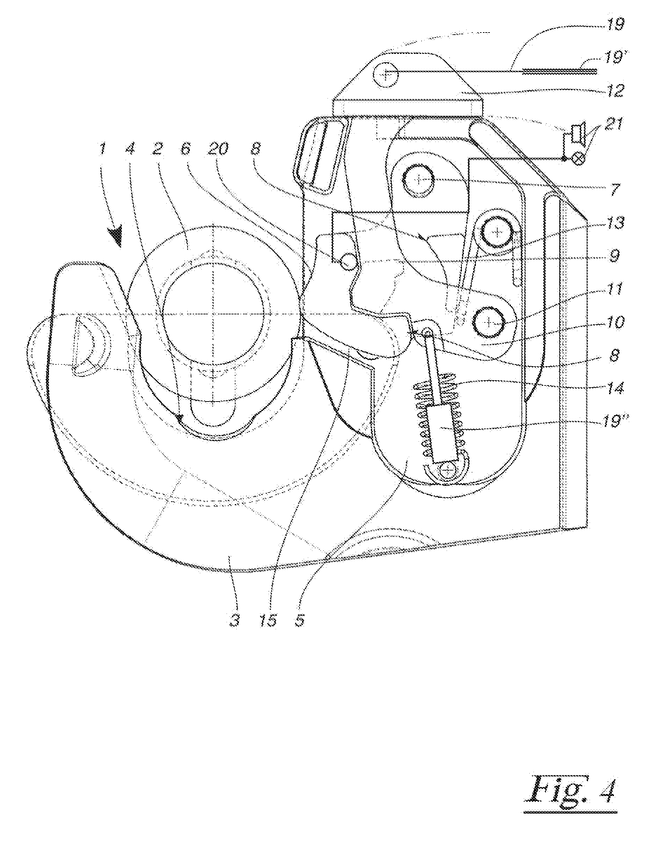

FIG. 4 shows the closure position of the coupling hook 1. This arises when the blocking lever 10 has reached the blocking position thereof. However, the safety catch 6 is still in the activation position thereof according to FIG. 3. By the coupling body 2 being further pressed in towards the receptacle 4, the safety catch 6 can be freely pivoted and is pivoted into the blocking position thereof according to FIG. 1 by the action of the torsion spring 13. In said position, the safety catch 6 is again retained by the interaction between the cam 9 and the blocking surface 8 such that the coupling body 2 is held securely in the receptacle 4 in the coupling hook 1.

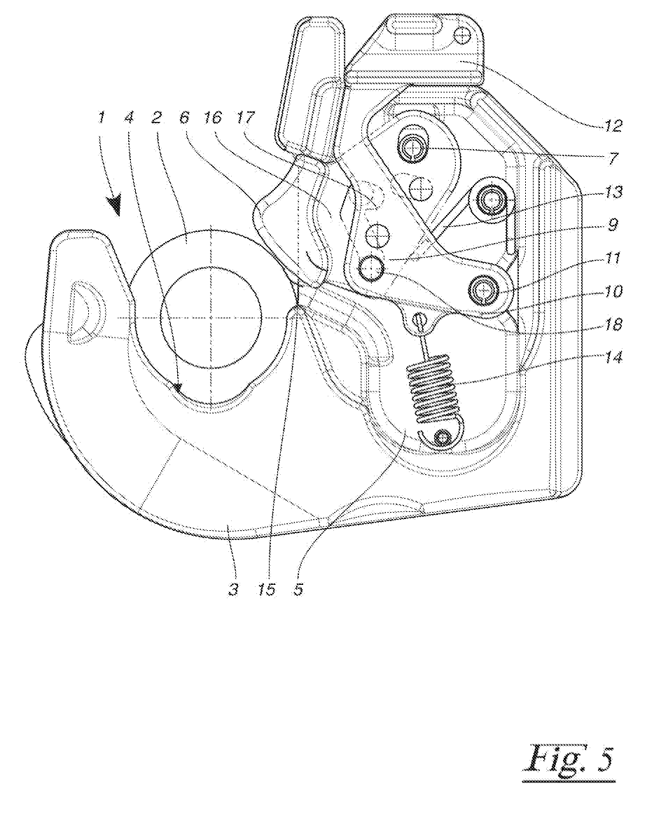

FIG. 5 shows an alternative embodiment of the coupling hook 1 according to FIG. 1, wherein the same reference numbers refer to the same parts. Only the differences over the embodiment according to FIG. 1 are discussed below.

In this embodiment, the guide surfaces 8 are modified to form a type of slotted guide 16. The cam 9 of the blocking lever 10 engages in said slotted guide 16. In order to lock the safety catch 6 in the blocking position illustrated, the slotted guide 16 has a latching recess 17 in said region.

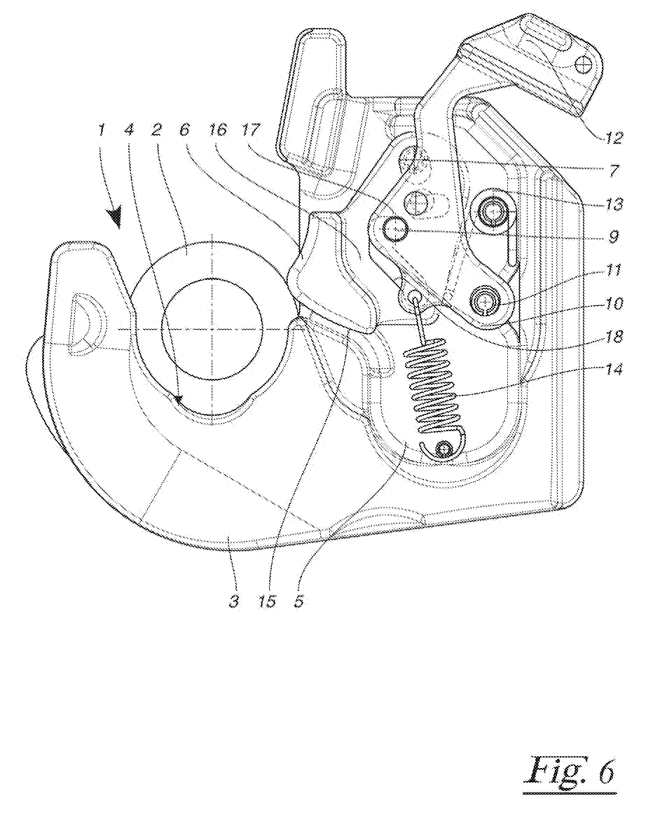

By pivoting of the blocking lever 10 in the direction of the release position thereof according to FIG. 6, the cam 9 enters a further latching recess 18 in the slotted guide 16. Said further latching recess 18 ensures that the blocking lever 10 is retained in the release position thereof.

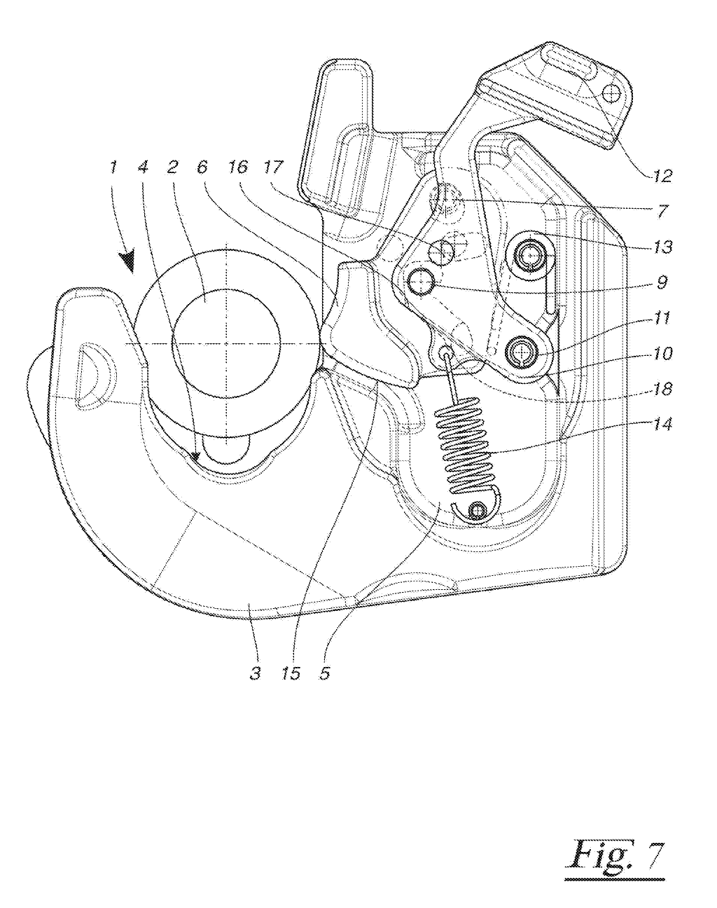

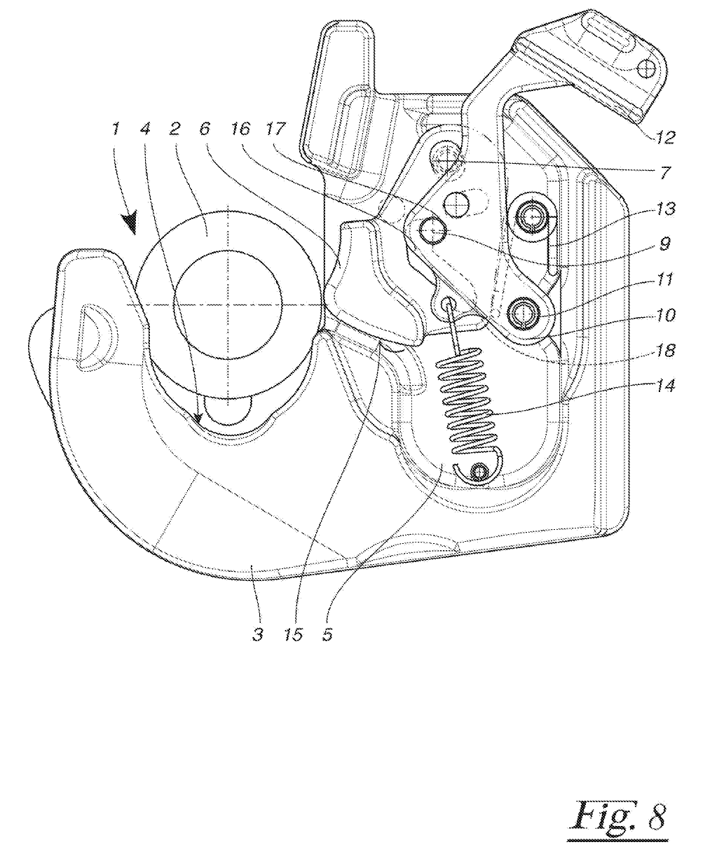

In the activation position according to FIG. 7, the blocking lever 10 can be freely pivoted and is moved by the tension spring 14 into the closure position, which is illustrated in FIG. 8.

Since some exemplary embodiments of the present invention are not shown or described, it must be understood that a multiplicity of changes and modifications of this exemplary embodiment described are possible, without departing from the essential idea and scope of protection of the invention defined by the claims.

### LIST OF REFERENCE NUMBERS

1 Coupling hook
2 Coupling body
3 Hook body
4 Receptacle
5 Receiving chamber
6 Safety catch
7 Axis
8 Guide surface
9 Cam
10 Blocking lever
11 Axis
12 Handle
13 Torsion spring
14 Tension spring
15 Roller
16 Slotted guide
17 Latching recess
18 Latching recess
19 Cable
19′ Bowden cable
19″ Lifting cylinder
20 Sensor
21 Signal transmitter

1. Coupling hook for a lower link of an agricultural tractor, wherein said coupling hook comprising a hook body, at least one receptacle, at least one receiving chamber, at least one safety catch and at least one blocking lever, said at least one adjustable blocking lever comprising at least one cam, said at least one receptacle being designed for receiving a coupling body, and in said at least one receiving chamber, said at least one safety catch is held, said at least one safety catch can be adjusted between a locking blocking position engaging over said coupling body and a release position being pulled back into said at least one receiving chamber to an extent such that said coupling body can be removed from said at least one receptacle, wherein said coupling body, as it presses towards said at least one receptacle, can adjust said at least one safety catch into an activation position such that said at least one safety catch is subsequently automatically be transferred into said blocking position, if said coupling body reaches said at least one receptacle, and said at least one safety catch is operatively connected to said at least one cam, said at least one cam retaining said safety catch in said blocking position thereof, and therefore said at least one safety catch withstands a force originating from said coupling body and acting on said at least one safety catch, and said at least one safety catch can be transferred into said release position firstly by a force directed towards said at least one receptacle and secondly by adjustment of said at least one blocking lever.

2. Coupling hook according to claim 1, wherein said at least one safety catch can be adjusted to a limited extent in the direction of said at least one receptacle, and said at least one safety catch being pressable into said release position, if said at least one safety catch being adjusted in a hitching position with respect to said at least one receptacle.

3. Coupling hook according to claim 1, wherein said at least one blocking lever being resiliently prestressed towards said blocking position.

4. Coupling hook according to claim 1, wherein said at least one safety catch being resiliently prestressed towards said blocking position.

5. Coupling hook according claim 1, wherein said at least one safety catch comprising at least one of a slotted guide and a guide surface on which said at least one cam of said at least one blocking lever acts.

6. Coupling hook according to claim 5, wherein said slotted guide is provided with at least one latching recess in which said at least one cam of said at least one blocking lever engages in at least one of said blocking and said release position.

7. Coupling hook according to claim 5, wherein said slotted guide surface is provided with at least one latching recess in which said at least one cam of said at least one blocking lever engages in at least one of said blocking and said release position.

8. Coupling hook according to claim 6, wherein said latching recess being designed for said blocking position is shaped in such a manner that said at least one cam can emerge from said latching recess by adjustment of said at least one safety catch in the direction of said at least one receptacle.

9. Coupling hook according to claim 7, wherein said latching recess being designed for said blocking position is shaped in such a manner that said at least one cam can emerge from said latching recess by adjustment of said at least one safety catch in the direction of said at least one receptacle.

10. Coupling hook according to claim 5, wherein said slotted guide having a direction of movement between said blocking and said release position and said slotted guide being provided with at least one stop surface being oriented approximately transversely with respect to said direction of movement, said at least one cam bearing against said at least one stop surface in at least one of said blocking and said release position.

11. Coupling hook according to claim 5, wherein said slotted guide surface having a direction of movement between said blocking and said release position and said slotted guide surface being provided with at least one stop surface being oriented approximately transversely with respect to said direction of movement, said at least one cam bearing against said at least one stop surface in at least one of said blocking and said release position.

12. Coupling hook according to claim 10, wherein said at least one stop surface for the blocking position is shaped in such a manner said at least one cam is disengaged from said at least one stop surface by adjustment of said at least one safety catch in the direction towards said at least one receptacle.

13. Coupling hook according to claim 11, wherein said at least one stop surface for the blocking position is shaped in such a manner that said at least one cam is disengaged from said at least one stop surface by adjustment of said at least one safety catch in the direction towards said at least one receptacle.

14. Coupling hook according to claim 1, wherein said at least one blocking lever is acted upon by at least one of a lifting cylinder, a Bowden cable and a cable, transferring said at least one blocking lever into said release position.

15. Coupling hook according to claim 1, wherein said at least one safety catch being provided with at least one roller, said at least one roller preventing transmission of torques from said coupling body to said at least one safety catch.

16. Coupling hook according to claim 15, wherein said at least one roller engaging with said coupling body only if said at least one a safety catch being pivoted upwards.

17. Coupling hook according to claim 1, wherein said at least one safety catch comprising at least one sensor for monitoring whether said at least one safety catch being in said blocking position thereof.
